(19) United States
(12) Patent Application Publication
(10) Pub. No.: US 2006/0271552 A1
(43) Pub. Date: Nov. 30, 2006

(54) Targeted delivery of content

(75) Inventors: Jeffrey Alan McChesney, Ridgefield, CT (US); Thomas P. McClain, Ridgefield, CT (US)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Venture Capital & Consulting Group, LLC.

(21) Appl. No.: 11/349,850

(22) Filed: Feb. 8, 2006

Related U.S. Application Data
(60) Provisional application No. 60/684,685, filed on May 26, 2005.
(60) Provisional application No. 60/696,617, filed on Jul. 5, 2005.

(51) Int. Cl. G06F 17/30

(52) U.S. Cl. 707/10

(57) ABSTRACT

There is provided a computer-implemented method for targeted delivery of content. The method includes (i) receiving first data that indicates (a) an identity of a person, (b) a subject location, and (c) a subject time at which the person is expected to be at the subject location, (ii) querying a database, based on the identity, to obtain second data about the person, (iii) matching content to the second data, and (iv) initiating a delivery of the content to a delivery location at a delivery time based on the subject location and the subject time.

### CROSS-REFERENCE TO RELATED APPLICATIONS

The present application is claiming priority of (a) U.S. Provisional Patent Application Ser. No. 60/684,685, filed on May 26, 2005, and (b) U.S. Provisional Patent Application Ser. No. 60/696,617, filed Jul. 5, 2005. The content of each of these applications is herein incorporated by reference.

### BACKGROUND OF THE INVENTION

1. Field of the Invention

The present disclosure relates to delivery of content to a targeted recipient, and more particularly, to a delivery based on knowledge that the targeted recipient is expected to be at a particular location at a particular time.

2. Description of the Related Art

In mass-market advertising, an advertiser provides an advertisement to a mass audience in a hope that a party to whom the advertiser wishes the advertisement to be delivered, i.e., a target recipient, is a member of the audience. Common examples of mass-market advertising include newspaper ads, billboards, radio ads and television commercials. Mass-market advertising also exists in forms such as personal solicitation (e.g., telemarketing), mass mail, or via the Internet, for example in an email solicitation or a pop-up ad.

Typically, the target recipient is a person or group of people that the advertiser believes has an interest in a product or service being promoted by the advertisement, and/or to whom the advertiser wishes to introduce the product or service. In mass-market advertising, the advertiser may direct the advertisement to a particular advertising venue, e.g., a particular newspaper, based on a collective demographic profile of an audience of that particular venue. However, even though the target recipient may be a member of the audience, such an advertisement is not customized for any particular member of the audience, and so, also not customized for the target recipient. Thus, in mass-market advertising, the target recipient is nevertheless an anonymous target recipient who happens to share some demographic characteristic with other anonymous target recipients.

One-to-one advertising is a technique in which an advertiser attempts to specifically deliver a particular advertisement to the target recipient. One-to-one advertising, when properly employed, is beneficial to both of the advertiser and the audience. The advertiser benefits because advertising expenditures are being utilized to inform or persuade an interested audience, and therefore, not being wasted on a non-interested party. The target recipient benefits because it receives information in which it is, or might be, interested. One-to-one advertising also benefits parties that are not being targeted, because such parties are not being bothered by an otherwise unwelcome solicitation, unwelcome item of junk mail, unwelcome item of junk email (spam) or unwanted pop-up ad. In view of these benefits, one-to-one advertising is considered by many advertisers to be more efficient than mass-market advertising, and also considered by the audience as being more agreeable and less invasive than mass-market advertising.

A successful one-to-one advertising campaign is based, at least in part, on knowing that a particular target recipient exists, and also on matching an appropriate advertisement to that target recipient. As such, an advertiser would ordinarily welcome any insight into the existence of a target recipient, and would also welcome assistance in identifying advertisements in which the target recipient would have an interest.

### SUMMARY OF THE INVENTION

There is provided a computer-implemented method for targeted delivery of content. The method includes (i) receiving first data that indicates (a) an identity of a person, (b) a subject location, and (c) a subject time at which the person is expected to be at the subject location, (ii) querying a database, based on the identity, to obtain second data about the person, (iii) matching content to the second data, and (iv) initiating a delivery of the content to a delivery location at a delivery time based on the subject location and the subject time.

A technical effect of the method is the use of a database to obtain data about a person, match content to the data, and initiate delivery of the content based on knowledge that the person is expected to be at a particular location, at a particular time.

### BRIEF DESCRIPTION OF THE DRAWINGS

FIG. 1 is a block diagram of a system that provides for delivery of targeted content to a targeted recipient.

FIG. 2 is a block diagram of another system that provides for delivery of targeted content to a targeted recipient.

### DESCRIPTION OF THE INVENTION

A technique described herein involves a delivery of content to a target recipient. The technique is particularly suitable for content such as an advertisement, however, it also suitable for other types of content such as news, entertainment, e.g., a movie or a game, and more generally, any type of information that may be of interest to the target recipient.

The technique takes advantage of knowledge that the target recipient intends to be at a particular place at a particular time, a condition also referred to as being captive. Such knowledge can be obtained, for example, from a reservation system directly, or indirectly from another database to which the reservation system is linked and communicates. Additional information about the target recipient is then obtained from a database, and based on the additional information, appropriate content is selected and delivered to the target recipient. The time of delivery is based on the aforementioned knowledge that the target recipient intends to be at a particular place at a particular time to receive and use services, for which the recipient has previously contracted or reserved, or is currently contracting or reserving. Selecting is a process whereby records that possess similar or identical attributes have been identified, then they are either combined into a new data set, or attributes from one data set are appended to a record of the other data set. Example: A name and an address are provided from an interface to a data company, which the data company processes to match to a record within the data company's database with the same or similar name and address. The data company could append one or more data attributes (such as gender or income level) and return the appended records to the interface. In another instance, the names and addresses are provided to a data company, which the data company processes to identify records that possess additional attributes. The data company could group identified records by one or more specific attributes and create a new data set, such as ages.

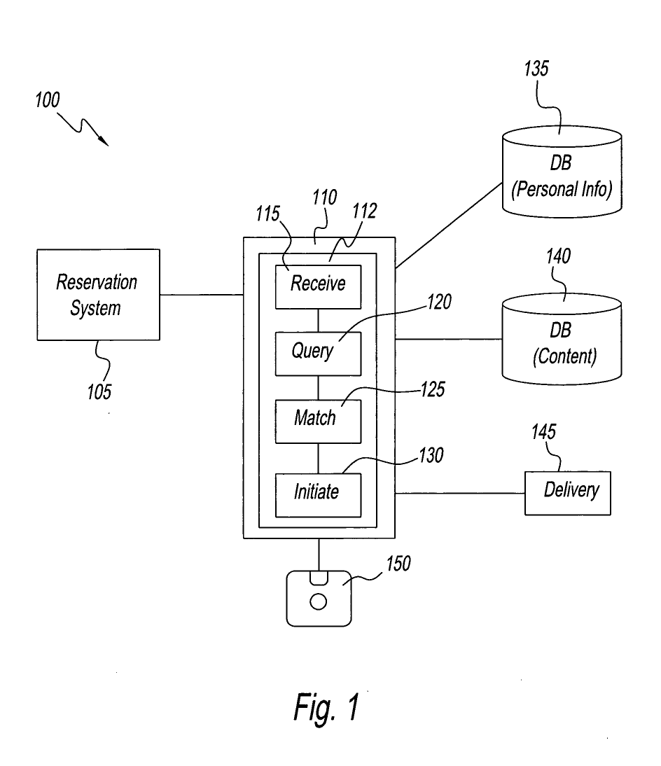

FIG. 1 is a block diagram of a targeted content delivery system (TCDS), i.e., system 100, that provides for delivery of targeted content to a targeted recipient. System 100 includes a reservation system 105, a processor 110, a database 135, a database 140, and a delivery coordinator 145.

Reservation system 105 contains data that indicates (a) an identity of a person, i.e., the target recipient, (b) a subject location, and (c) a subject time at which the person is expected to be at the subject location. Reservation system 105 can be any system that provides this data, for example, an appointment system at a dentist's office that indicates that John Doe intends to be at the dentist's office for a root canal on Dec. 1, 2005, at 10:00 AM. For purpose of an example being described below, assume that reservation system 105 is an airline reservation system.

Preferably, the identity of the person is indicated by combination of (i) a name of the person and (ii) an attribute associated with the person, such as a mailing address, a telephone number, an account number, an email address, or a password. The data may also indicate a purpose of the person being at the subject location at the subject time, e.g., business or pleasure.

Database 135 contains additional information about the person. Such information could indicate, for example, the person's age, languages spoken by the person, the person's medical conditions, types of music preferred by the person, organizations of which the person is a member, and hotels at which the person has stayed in the past three years.

Database 140 is a database of content. As mentioned above, in general, the content can be any type of information that may be of interest to a target recipient, but for purpose of example, assume that database 140 includes information regarding musical performances at venues throughout various cities, information about various businesses in the cities, and sound recordings.

Delivery coordinator 145 coordinates delivery of content to the target recipient. Delivery can be in the form of electronic delivery, delivery via courier, or having a party present the content at the delivery location. Thus, the content, when delivered, may be in either an electronic format, e.g., a transmission delivered via the Internet, or a physical format, e.g., a brochure.

Processor 110 is a computer processor. As such, it may be implemented on a general-purpose microcomputer, such as one of the members of the Sun™ Microsystems family of computer systems, or one of the members of the IBM™ Personal Computer family. Processor 110 includes an associated memory 112 for storing data and instructions for controlling the operation of processor 110, and more particularly, contains program modules 115, 120, 125 and 130. The term “module” is used herein to denote a functional operation that may be embodied either as a stand-alone component or as an integrated configuration of a plurality of sub-ordinate components.

Program module 115 contains instructions for controlling processor 115 to receive data from reservation system 105 that indicates (a) an identity of a person, (b) a subject location, and (c) a subject time at which the person is expected to be at the subject location. For example, assume that processor 110 receives data that indicates that, John Doe intends to be on FLT 1000, seat 101, to Hartford, Conn., which leaves on Friday, Dec. 2, 2005, at 3:00 PM, and that Mr. Doe is traveling for pleasure.

Program module 120 contains program instructions for controlling processor 110 to query database 135, based on the identity of the person, to obtain additional data about the person. For example, based on the identity data of John Doe, processor 110 obtains information from database 135 that indicates that John Doe is age 67, speaks English and French, has a prosthetic leg, enjoys jazz and classical music, is a member of a Classical Guitar Society, and in the past three years has stayed at five hotels having casinos, and all of the hotels are rated as having three or more stars.

Program module 125 contains program instructions for controlling processor 110 to match content from database 140 to the additional data obtained from database 135. Matching is a process that automatically compares attributes from records within one or more databases to identify attributes that are similar or identical. An example is a keyboard search on ‘brown’ that identifies records that possess that attribute as a data field. In a case where the data from reservation system 105 indicates the purpose of the person being at the subject location at the subject time, the match can also be based on the purpose. So, for example, processor 110 matches the additional information about John Doe to a list of three venues in Hartford, Conn., at which there will be performances of live jazz or classical music on Saturday, Dec. 3, 2005. Two of the venues are upscale restaurants that are also handicapped accessible, and the third venue offers a senior citizens discount, but is not handicapped accessible. Processor 110 may also make additional matches, thus yielding a plurality of content items, based on the additional data from database 135. In this regard, assume that processor 110 also matches the additional information to a list of French audio recordings, and a list of interactive gambling sites.

Program module 130 contains program instructions for controlling processor 110 to initiate a delivery of the content to a delivery location at a delivery time based on the subject location and the subject time that processor 110 received from reservation system 105. For example, assume that FLT 1000, seat 101 has associated therewith an electronic user interface, such as an interactive video display. Processor 110 instructs delivery coordinator 145 to transmit the list of venues, the list of French audio recordings, and the list of interactive gambling sites to the electronic user interface at FLT 1000, seat 101, on Saturday, Dec. 3, 2005, at 3:30 PM. Furthermore, through interaction with the user interface, Joe Doe is given an opportunity to reserve a seat at the performances, listen to the French audio recordings, and gamble at the interactive gambling site. In an alternative arrangement, processor 110 instructs delivery coordinator 145 to schedule a delivery of a package of content to FLT 1000, seat 101, on Saturday, Dec. 3, 2005, by a party such as a flight attendant. In either case, system 100 facilitates a one-to-one delivery of content customized for John Doe.

Note that the delivery time and delivery location of the content by delivery coordinator 145 need not be the same as the subject time and the subject location that processor 110 received from reservation system 105. The delivery can occur either before or after the subject time, and at a location other than the subject location. In one alternative, processor 110 instructs delivery coordinator 145 to send a package of content to John Doe at his home address, via courier, so that the package will arrive on or about Nov. 25, 2005, i.e., about one week before the flight. The content in the packages not only provides the list of venues for the performances, but also includes information about restaurants near the venues, and about car services in Hartford. In another alternative, processor 110 instructs delivery coordinator 145 to send an email to John Doe on or about Dec. 9, 2005, i.e., about one-week after the flight, seeking his feedback as to whether he attended any of the musical performances.

An act of a person providing data that identifies the person is referred to herein as a self-declaration. Thus, when John Doe himself provides data that indicates his identity, (b) a subject location, and (c) a subject time at which he is expected to be at the subject location, he is making a self-declaration. Mr. Doe is also making a self-declaration when he arrives at the subject place at the subject time, and identifies himself.

Assume that John Doe is presently at a terminal (not shown). Such a terminal might be at an airport or on an aircraft. There are at least two instances in which self-declaration may occur. The first is if a known (TCDS-aware) passenger sits in the wrong seat. The second is if a person is unknown to the TCDS. In either instance, the system will ask for information from the passenger. This is self-declaration. Thus, John Doe himself provides the data that indicates his identity, (b) a subject location, and (c) a subject time at which he is expected to be at the subject location.

Furthermore, the subject location is not necessarily a stationary location, that is, the location may vary with time. This is particularly evident in the case of the subject location being a seat on an aircraft. Although the seat is stationary with respect to the aircraft, the location of the aircraft, and so the location of the seat, are varying with time.

While program modules 115, 120, 125 and 130 are indicated as already being loaded into memory 112, they may be configured on a storage media 150 for subsequent loading into memory 112. Storage media 150 can be any conventional storage media such as a magnetic tape, an optical storage media, a compact disk, or a floppy disk. Alternatively, storage media 150 can be a random access memory, or other type of electronic storage, located on a remote storage system.

Moreover, although program modules 115, 120, 125 and 130, are described herein as being installed in memory 112, and therefore being implemented in software, they could be implemented in any of hardware, firmware, software, or a combination thereof.

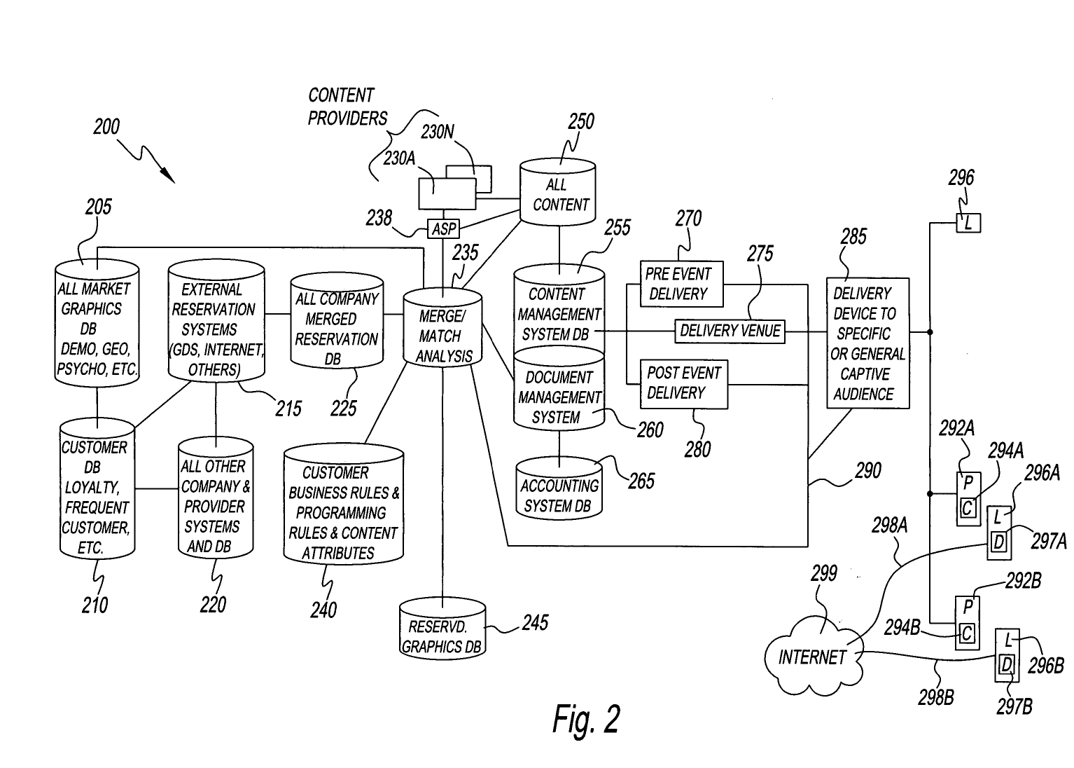

FIG. 2 is a block diagram of another TCDS, i.e., system 200, that provides for delivery of targeted content to a targeted recipient. System 200 includes databases 205, 210, 215, 220, 225, 235, 240, 245, 250, 255, 260, and 265, a pre-event delivery process 270, a delivery venue process 275, a post-event delivery process 280, and a delivery device process 285. Each of databases 205, 210, 215, 220, 225, 235, 240, 245, 250, 255, 260, and 265 includes an associated processor (not shown) for operating its respective database, and performs conventional database operations such as (i) interfacing with other devices, and (ii) storing, merging, searching and retrieving data. System administrators provide routine interface and maintenance to all databases, for example, reprogramming for inputs and outputs, human interactions for analyses of operations, system security, individual permissions and authorizations, integrating features for growth, integrating new functions, and integrating software and hardware upgrades.

In FIG. 2, lines between components represent a flow of data. The data flow includes a feedback loop 290, designated with a dashed line. Feedback loop 290 flows from processes 270, 275, 280 and 290, to databases 235 and 265.

System 200 receives content from one or more content providers 230A-230N. Examples of content provider 230A-230N include, media companies, and ad agencies. Examples of content include digital media, hardcopy media, games, gambling, pay to view media, how-to media, books on tape, movies, and music.

Database 205 is a market graphics database, e.g., demographic, geographic, psychographic, physiographic, firmographic and genographic data. Database 205 receives data from database 235, and from databases 210, 220, i.e., data from database 200. Database 205 performs operations, as shown, but not limited to those, as set forth in TABLE 1, and provides (a) demographic outputs as set forth in TABLE 2, (b) geographic outputs as set forth in TABLE 3, (c) psychographic outputs as set forth in TABLE 4, (d) physiographic outputs as set forth in TABLE 5, (e) firmographic outputs as set forth in TABLE 6, and (f) genographic outputs as set forth in TABLE 7. Business Rules, as first shown in TABLE 1, are an instruction or set of instructions that codify an action(s) to take with data to accomplish specific objectives. Example: an advertiser/content owner sets a business rule such that the TCDS identifies male passengers on a specific flight and sends them specific advertising or content. Segmenting is the act dividing a large group of people, such as passengers, into smaller groups of people with identical or similar demographic, and/or psychographic, and/or geographic, and/or physiographic, and/or firmographic and/or genographic characteristics. Data cleansing and quality improvements are processes of identifying elements in a database that are inaccurate or out of date, and finding sources or conducting actions to obtain correct data to replace the incorrect data or out of date data. This cleansing process improves the overall database quality. Modeling is the process of identifying a specific act of a person or persons and then using profile data to identify a similar set of persons who have not yet demonstrated or performed that specific act. Clustering is the process of grouping persons or objects based on identified affinity of those persons or objects. Further, a cluster that has a greater affinity to another cluster may be graphically or visually portrayed nearer that cluster, than to one it has less affinity with. Classification is the process of codifying a person or persons once any or all of the processes of selecting, matching, segmenting, modeling and clustering have been completed, to enable the TCDS to identify a person or persons as an appropriate recipient of specific content consisting of programming or advertising. Data matching and updating is ostensibly the same as data cleansing and quality improvements, except that new data elements, which were not previously part of the record, may be added. Data merging is the process, after matching has occurred, of adding unique data from one database record to the similar record from another database.

TABLE 1
Database 205 Operations

Generates reports (market graphics)
Loads and uses business rules
Data acquisition and storage
Data cleansing and quality improvements
Data manipulation: modeling, clustering, classification, segmentation
Data matching and updating
Data merging
Feedback mechanism applications
Applies limits and regulatory requirements (e.g., “Do Not Call” list)
Order construction and output for orders via various forms and media
Accounting
Logging (logging is creating a date/time stamp record of all transactions
with a database)
Manages queries and responses
Records, tracks and updates inventory of all data elements
Internal systems operations: scheduling, capacity, timing,
memory, allocations
Performs security functions, and permissions

TABLE 2
Database 205 Demographic Outputs

Name
Gender
Age ranges
Age
Birth month
Birth date
Marriage/single census data, family info
Ethnicity
Citizenship
Occupation/Employment
Profession
Education
Names in household
Age of children
Religion
Language
Telephone number
Prefix designations/titles
Marriage date
Country of origin
Children present in household
Household with grandparents

TABLE 3
Database 205 Geographic Outputs

Address
Own/Rent/Apt #
Latitude and longitude
Block #
Nationality
Region
Geographic-segmentations
County (e.g., standard metropolitan statistical area (SMSA))
Metropolitan area
Phone number and area code
Timezone
Carrier route number (e.g., post office sorting)
Delivery barcode for US Postal Service
Contact application types (e.g., phone, mail)

TABLE 4
Database 205 Psychographic Outputs

Leisure activities
Home value
Estimated income
Survey data
Car registration
Preferences
Lifestyle
Shopping patterns
Affiliations/clubs
Entertainment
Travel
Mobility
Pet Ownership (y/n, cat, dog)
Residence type
Location type
Number of units
Credit card type(s)
Number of trade lines
Mail order buyer's code
Mail responsiveness
Donor/Contributions
Household with: cats, dogs, veterans, high-tech individuals,
and interest in investing
Estimated home value
Home sales price
Home built year
Female occupation
Male occupation
Vehicle group
Vehicle count
number of vehicles purchased in model year/s
Recreation vehicle owner
Truck owner
Motorcycle owner
Active consumer indicator
Vehicle year and model
Head of household indicator
Purchasing power indicator
Mail order history, last purchase
Household with Internet
Net worth ranking
Potential investor
Number of credit cards
Heavy Internet user
Length of residence
Location type
Unit Size
Pool
Home owner/renter
Home value source
Mortgage amount
Mortgage type
Mortgage sale and date
Finance type

TABLE 5
Database 205 Physiographic Outputs
Biometric Characteristics

Height
Weight
Hair color
Health
Donor type

TABLE 6
Database 205 Firmographic Outputs

Company name
Address
Standard Industry Classification/North
American Standard Industry Classification
(SIC/NAICS) Codes
Position/Title
Tenure
Corporate profile
Contact information

TABLE 7
Database 205 Genographic Outputs

Gene type
Characteristics
Defects
Classes
Relationships

The genographic outputs listed in TABLE 7 are segmentations resulting from genome research. It facilitates marketing products and services to a gene segmented society, just as is done for age segmentations. For example, system 200 may provide articles on food and lifestyles that tend to prevent or mitigate cancer to people that carry a specific gene or set of genes that make those people highly likely to contract cancer in their lifetime.

Database 210 is a customer database, e.g., loyalty and frequent customer data. Database 210 receives data from databases 205, 215 and 220, i.e., data from database 200. Additionally, from external sources and interfaces, database 210 receives customer application profile inputs, inferred and explicit customer profile data, and purchase data to initiate points and awards. Database 210 performs operations as set forth in TABLE 8, and provides outputs as set forth in TABLE 9.

TABLE 8
Database 210 Operations

Generates reports
Loads and uses business rules
Data acquisition and storage
Data cleansing and quality improvements
Data manipulation: modeling, clustering, classification, segmentation
Data matching and updating
Data merging
Feedback mechanisms applications
Applies limits and regulatory requirements (e.g., “Do Not Call” list)
Order construction and output for orders via various forms and media
Accounting
Logging
Manages queries and responses
Records, tracks and updates inventory
Internal systems operations: e.g., scheduling, capacity, timing,
memory, allocations
Performs security functions, and permissions
Tracking purchasing histories of system audience,
as well as affiliate's data
Redemption activities
Assigns rewards

TABLE 9
Database 210 Outputs

Number
Prefix
First Name
Last Name
Middle initial
Suffix
Address home
Address business
Company name
Phone number home
Phone number business
Phone number cell/mobile
Phone number fax
Home airport
email addresses
HTML/TEXT desires
Info verification (e.g., real street in town)
Travel history data
Miles available
Miles used
Awards
Awards used

Database 215 is an external reservation system database, e.g., global distribution systems (GDS) and Internet. GDS includes Sabre®, Galileo®, Amadeus® and Worldspan®. “Sabre” is a registered trademark of Sabre, Inc., “Galileo” is a registered trademark of Galileo International, Amadeus” is a registered trademark of Amadeus Development S.A., and “Worldspan” is a registered trademark of Worldspan, L. P. Database 215 receives data from databases 210, 220 and 225 i.e., data from database 200. Additionally, from external sources and interfaces, database 215 receives user reservation and appointment data, reservation agent data, and data relating to contract terms with airlines. Database 215 performs operations as set forth in TABLE 10, and outputs passenger name record (PNR) data.

TABLE 10
Database 215 Operations

Name, address, contact telephone numbers, email
Flight number
Seat number
Times & dates (intended reservation)
Travel itinerary details
To/From current locations
Class of service
Specific attributes of venue that can be
personalized (e.g., wheelchair, Kosher meal)
Internal and affiliate schedules of resources
Other Names on PNR
Frequent flyer or loyalty program information
Inventory and availability
Types of ticket (e.g., 1-way, round-trip, open-jaw)
Intermodal information
Transit locations
Transfer delays and durations
Seat information
Manages power supply
Payment Information
Billing Address
Non-Air components of itinerary
Ticket number
General Remarks
Date of ticket issuance
Received from information

Database 220 represents other company and provider system databases. Database 220 receives data from databases 210 and 215, i.e., data from database 200. Database 220 performs operations as set forth in TABLE 11, and provides outputs as set forth in TABLE 12.

TABLE 11
Database 220 Operations

Generates reports
Loads and uses business rules
Data acquisition and storage
Data cleansing and quality improvements
Data manipulation: modeling, clustering, classification, segmentation
Data matching and updating
Data merging
Feedback mechanisms applications
Applies limits and regulatory requirements (e.g., “Do Not Call” list)
Order construction and output for orders via various forms and media
Accounting
Logging
Manages queries and responses
Records, tracks and updates inventory
Internal systems operations: e.g., scheduling, capacity, timing, memory,
allocations
Performs security functions, and permissions
Tracking purchasing histories of system audience, as well as affiliate's
data
Redemption activities
Assigns rewards
Scheduling
Capacity and planning
Yield management

TABLE 12
Database 220 Outputs

Customer Profile databases
Partner Loyalty information/program data
Associate company activity (e.g., car, hotel)
An example of internal for an airline(e.g., capacity planning, baggage
claim)
Internal and affiliate schedules and resource planning
Any other output from any other System 200 database, plus any data from
an airline's other databases or from a content provider, which may
indirectly enter System 200's databases.

Database 225 is a database of merged reservation data. Database 225 receives data from databases 215 and 235, i.e., data from database 200. Database 225 performs operations as set forth in TABLE 13, and provides outputs as set forth in TABLE 14.

TABLE 13
Database 225 Operations

Name, address, contact telephone numbers, email
Flight number
Seat number
Times & dates (intended reservation)
Travel itinerary details
To/From current locations
Other names on PNR
Frequent flyer or loyalty program information
Inventory and availability
Intermodal information
Transit locations
Transfer delays and durations
Seat information
Manages power supply
Payment information
Billing address
Non-air components of itinerary: e.g., accommodations; car rental;
rail reservations; tours; cruises; other modal information
Travel agency
Travel agent name and identification data
Codeshare PNR information
Split/divided PNR information
Ticket number
Ticketing field information: e.g., class of service; codes; prices
General remarks
Date of ticket issuance
No show history
Bag tag history
Other Services Information (OSI)
Special Services Information/Special Services Request (SSI/SSR)
Received from information
Historical changes to PNR
Advance Passenger Information System (APIS) information: e.g.,
complete name; date of birth; citizenship; sex; passport number; country of
issuance; alien registration; USA address while in US
Automatic Ticket Fare Quote (ATFQ) fields
Flags for delays(flight delays, flight departure changes, flight
cancellations) may be in reservations databases, as well as information
for: transfer delays, transfer locations

TABLE 14
Database 225 Outputs

Name, address, contact telephone numbers, email
Flight number
Seat number
Times & dates (intended reservation)
Travel itinerary details
To/From current locations
Other names on PNR
Frequent flyer or loyalty program information
Inventory and availability
Intermodal information
Transit locations
Transfer delays and durations
Seat information
Payment information
Billing address
Non-air components of itinerary: e.g., accommodations; car rental;
rail reservations; tours; cruises; other modal information
Travel agency
Travel agent name and identification data
Codeshare PNR information
Split/divided PNR information
Ticket number
Ticketing field information: e.g., class of service; codes; prices
General remarks
Date of ticket issuance
No show history
Bag tag history
Other Services Information (OSI)
Special Services Information/Special Services Request (SSI/SSR)
Received from information
Historical changes to PNR
Advance Passenger Information System (APIS) information: e.g.,
complete name; date of birth; citizenship; sex; passport number;
country of issuance; alien registration; USA address while in US
Automatic Ticket Fare Quote (ATFQ) fields
Flags for delays(flight delays, flight departure changes, flight
cancellations) may be in reservations databases, as well as information
for: transfer delays, transfer locations

Database 235, is a database of merge/match analysis data. Database 235 (a) receives data from databases 205, 225, 240, 245, 250, 255 and 260, and (b) via feedback loop 290, receives data from processes 270, 275, 280 and 285, i.e., data from database 200. For example, database 235 receives content attributes from database 250, reservation attributes from database 225, customer business rules, programming rules and content attributes from database 240, document management system attributes from database 260 and advanced targeting data from database 245. Content attributes are descriptors about, for example, a type (e.g., audio, video, pictures), format (e.g., MPEG, MPEG-2, MPEG-4, JPEG, .wav, XML, HTML), duration (if applicable), ownership, pricing, business rules, digital rights management. Reservation attributes are outputs of database 215 and database 225. Programming rules are specific business rules providing instructions about how to utilize content. Programming rules are a subset of business rules. Document Management System attributes contain metadata about content, primarily focused on where the content is, when it is allowed to be used, by whom, how often, including revisions, archive instructions, destruction instructions, and it tracks and directs communications about its contents to control the overall process. Database 235 performs operations as set forth in TABLE 15, and provides outputs as set forth in TABLE 16.

Database 235's inputs consist of the following: Content attributes from database 250; reservation attributes from database 235; Customer Business Rules, Programming Rules and content attributes from database 240; Document Management System attributes from database 260; advanced targeting data from reservographics database 245; quality response data, survey data, and other feedback from Feedback Loop 290; regulatory and policy limits and restrictions from database 240;

TABLE 15
Database 235 Operations

May mask reservation data due to regulatory or policy requirements, that is when
system 200 sends data from one database to another, its original source may not be
revealed, and may be masked.
Calculating content vs. audience matrix (an array)
Determining resource/venue delivery methods, types and allocations (e.g., seatback server,
handheld, overhead)
Matching content attributes to customer profiles
Merging like customer profiles for content delivery as a result of clustering and classifying
Quantifying audience and identifying flights on which audience will be captive
Collating survey responses, analyzing, and reporting quality indicators for system 200,
as well as with the other uses
Maintains master list of schedules, display devices inventory (e.g., In-Flight
Entertainment (IFE) equipment types, locations, capabilities), content, rules, audience,
groupings, categories, clusters, and with the other segmentations
Creates updates for reservographics database (i.e., database 245)
Maintains prices schedules and performs analysis and optimization algorithms/routines
Processes and applies feedback and survey data for quality improvements
Processes and applies accounting flags for content delivery productivity improvements
Manages systems operation and administration
Interfaces with other operating systems or components external to this entire system
Data cleansing and reconciliation

An example of the audience matrix mentioned in TABLE 15 is a table comprising specific groups of pre-coded consumers that cross-match to specific content offerings. TABLE 15A is an exemplary audience matrix.

TABLE 15A
Audience Matrix

| | Consumer | Consumer | Consumer | Consumer |
|---|---|---|---|---|
| Content Type | Group 1 | Group 2 | Group 3 | Group 4 |
| A | X | | | X |
| B | | X | X | |
| C | X | | X | |
| D | | X | | X |

TABLE 16
Database 235 Outputs

Content matched to audience matrix (who, what, where, when, how, why),
to databases 255 and 260
Specific delivery device location/address of audience, to databases 255 and
260 Content rules to database 255, either directly or indirectly
Data to database 245
Queries and perfecting data to database 205
Queries and confirmations
Interface devices and reports to system administrator
Optimization data and commands

Database 240 is a database of customer business rules, programming rules and content attributes. Generally, database 240 is concerned with what system 200 does for an ad/content owner, and is also concerned with internal marketing needs. Database 240 receives data from database 235 or entered directly by system administrators. Database 240 performs operations as set forth in TABLE 17, and provides outputs as set forth in TABLE 18.

TABLE 17
Database 240 Operations

Loads and uses business rules
Data acquisition and storage
Data cleansing and quality improvements
Data matching and updating
Data merging
Feedback mechanisms
Applies limits and regulatory requirements
Order construction and output
Pricing
Accounting
Logging
Assigns content demand requirements

TABLE 18
Database 240 Outputs

Content delivery requirements:
Frequency
Targeted audience
Cost/Price
Method
Duration and periodicity
Distribution
Limits
Regulatory requirements

Database 245 is a reservographics database. Generally, database 245 receives data from all of the other databases, and analyzes and stores the data over time to determine whether there is an opportunity to improve performance of system 200. Database 245 is a repository for all scheduled transactions data that are outputs of database 235 to the entire system 200, as well as all actual transactions from feedback loop 290. Database 245 performs operations as set forth in TABLE 19, and provides outputs as set forth in TABLE 20.

TABLE 19
Database 245 Operations

Compares data from other databases to data from feedback loop
290 to improve targeting
Provides data for analysis and execution of new business opportunities
Provides redundancy capability
Creates matrices and arrays of system data

TABLE 20
Database 245 Outputs

Refined and improved targeting criteria
Summary compilations and matrices of data and reports, i.e. system
administration data extracts
Reports of data

Database 250 is a content database. Database 250 receives data, i.e., content (programming and advertising), from content providers 230A-230N, aggregates the content, and transmits or transfers the aggregated content and content attributes to databases 235, 240, 255, 260. The transmission or transfer can be performed on a scheduled basis. In addition, database 250 prepares content attributes that include time, media, metadata, memory, bandwidth, royalties, payment data, owner data, and pricing data.

Database 255 is a content management system database. Database 255 receives data from databases 250 and 260, and also from process 270, 275 and 280 In addition, from database 250 and 260, database 255 receives content aggregation and distribution, timing and scheduling, updates to metadata tags, lock and unlock flags, revision controls, security controls, archive and retrieval commands, and storage commands and instructions. Database 255 performs operations as set forth in TABLE 21, and provides outputs as set forth in TABLE 22.

TABLE 21
Database 255 Operations

Sequences content for output, directs output to venue based on throughput,
time, and channel requirements
Stores digital content
Stores metadata tags for all content, including physical content
Generates reports
Indexes everything within databases 255 and 260
Performs fast searches
Disaggregates content, bursting into storage
Reaggregates content
Loads and uses business rules
Acquires data and stores
Cleanses data and quality improvement
Matching and updating
Merging
Feedback mechanisms
Applies limits and regulatory requirements
Order construction and output, via various forms and media
Logging
Generates reports about the content within database 255, about what
content was sent to various locations, what advertisements are scheduled
and sent, and other reports

TABLE 22
Database 255 Outputs

Content, format, type
Metadata (re: content and reservations): content owner, venue, delivery
device/method, attached business rules
Time
Schedule

Database 260 is a document management system database. Database 260 may be a standalone system, a subset, or an integral part of database 255. Database 260 receives data from databases 235, 250, 255, 265, 270, 275, 280, i.e., data from database 200. Database 260 performs operations as set forth in TABLE 23, and provides outputs as set forth in TABLE 24.

TABLE 23
Database 260 Operations

Sequences content for output, directs output to venue based on throughput,
time, and channel requirements
Stores digital content
Stores metadata tags for all content, including physical content
Generates reports of content movement, usage and revisions
Indexes everything in databases 255 and 260
Performs fast searches
Disaggregates content, bursting into storage
Reaggregates content
Loads and uses business rules
Acquires data and stores
Cleanses data and quality improvement
Matching and updating
Merging
Feedback mechanisms
Applies limits and regulatory requirements
Order construction and output, via various forms and media
Logging
Manages user lists, roles, functions and permissions
Accounting flags for orders and fulfillment
Revision tracking and controls
Grants approvals
Has text and graphical user interfaces
Locates content
Attaches, updates, and uses metadata
Tracks content workflow
Performs security functions
Opens/closes content files
Stores, locks, and unlocks previous versions of content
Performs delete functions
Directs archive and retrieval

TABLE 24
Database 260 Outputs

Content aggregation and distribution
Timing and scheduling
Updates to metadata tags
Lock and unlock flags
Revision controls
Security controls
Archive and retrieval commands
Storage commands and instructions
Content attributes including all digital rights management (DRM) data
Reservation attributes
Customer business rules, and programming rules, and content attributes
Document management system attributes
Advanced targeting data
Reprogramming and inputs and updates
Quality response data, survey data
System administration data
Human interactions w/optimization routines
Regulatory and policy limits and restrictions
System security protocols and permissions
Integrates additional scaling features, functions and factors

Database 265 is an accounting system database. Database 265 receives data from all other databases, and also receives data via feed back loop 290, i.e., data from database 200. Database 265 performs operations as set forth in TABLE 25, and provides outputs as set forth in TABLE 26.

TABLE 25
Database 265 Operations

Loads and uses business rules
Data acquisition and storage
Data cleansing and quality improvements
Data matching and updating
Data merging
Feedback mechanisms
Applies limits and regulatory requirements
Pricing
Accounting (Financial Accounting Standards Board (FASB) and
Generally Accepted
Accounting Practices (GAAP))
Logging
Tracking purchasing histories of own system and affiliates
Redemption activities
Assigns rewards
Manages internal scheduling, capacity, yields
Allocates funds for accounts receivable and accounts payable
Generates reports
Contract management and reconciliation

TABLE 26
Database 265 Outputs

Reports of all system costs, all system pricing, all usage at all
locations and all financial statements
Content Usage Flags

From database 225, database 235 receives data that indicates (a) an identity of a person, (b) a subject location, and (c) a subject time at which the person is expected to be at the subject location. Thereafter, databases 235 (i) queries database 205 to obtain additional data about the person, (ii) matches content from databases 240 and 250 to the additional data, and initiates delivery of the content to process 270, 275 and 280, the delivery locations, at a delivery time based on the subject location and the subject time.

Database 255 and/or processes 270, 275 and 280 manage timing of delivery, i.e., the delivery time, of the content, with respect to the aforementioned subject time, i.e., the time at which the person is expected to be at the subject location. Pre-event delivery process 270 operates to deliver the content before the subject time, delivery venue process 275 operates to deliver the content at the subject time, and post event delivery process 280 operates to deliver the content after the subject time.

Processes 270, 275 and 280 each receive data from database 255, and also have inputs as set forth in TABLE 27, perform operations as set forth in TABLE 28, and provide outputs as set forth in TABLE 29. These processes are described in further detail below.

TABLE 27
Inputs to Processes 270, 275 and 280

Self-declaration by audience
Content, electronic or physical
Directions to use content
Accounting flags
Metadata instructions
Requests from audience
Internet data packets
Business rules, either directly or indirectly, to include embedding
with metadata
Delivery devices addresses and configurations
Usage (feedback)
Error notices
Credit card or other financial payment data
Process operator interface inputs (external direct mail fulfillment
company, or the passenger)
Instructions/Interrupts (e.g., flight crew interrupts)
Offers and collates quality surveys and indicators and audience
profiles derived DURING captivity
Electronic forms generation, display, completion, and final delivery
to source (e.g., customs forms, health history, loyalty sign up)
Indicators of identification of audience members (e.g., smart cards,
biometric data, passwords)

TABLE 28
Processes 270, 275 and 280 Operations

Accepts targeted content
Electronic or physical (e.g., magazines, coupon) distribution systems
Allocates or passes through targeted content
Logging
Storing
Aggregating/Disaggregating content for one or more audience
devices/members
Acknowledges and reports usage data
Sequencing by following directions and commands from databases
255 and 260 and/or process operator and/or passenger inputs
Sets accounting flags
Reads and executes metadata instructions
Senses and reports errors and faults
Processes requests from audience
Can incorporate a connected, or temporarily disconnected subordinate
Document
Management System/Content Management System, DMS/CMS
Can be an Internet server, file server
Can be a data loader and verifier
Can function as a router
Can accept and execute business rules
Matches metadata directions against delivery device addresses and
availability
Merges Internet streams with all targeted content
Generates feedback data
Applies limits and regulatory requirements (e.g., if plane goes below
10k feet, interrupts operations, stops content)
Matches audience instructions against content
Creates internal request tickets from audience
If required, can undertake system operations (e.g., scheduling, capacity,
memory allocations)
Performs security functions
Performs ongoing monitoring and fault identification

TABLE 29
Processes 270, 275 and 280 Outputs

Accepts targeted content
Electronic or physical (e.g., magazines, coupon) distribution systems
Allocates or passes through targeted content
Logging
Storing
Aggregating/Disaggregating content for one or more audience
devices/members
Acknowledges and reports usage data
Sequencing by following directions and commands
Sets accounting flags
Reads and executes metadata instructions
Senses and reports errors and faults
Processes requests from audience
Can incorporate a DMS/CMS
Can be an Internet server, file server
Can be a data loader and verifier
Can function as a router
Can accept and execute business rules
Matches metadata directions against delivery device addresses
and availability
Merges Internet streams with all targeted content
Generates feedback data
Applies limits and regulatory requirements (e.g., if plane goes below
10k feet, interrupts operations, stops content)
Matches audience instructions against content
Creates internal request tickets from audience
If required, can undertake system operations (e.g., scheduling, capacity,
memory allocations)
Performs security functions
Performs ongoing monitoring and fault identification
Operator instructions (e.g., flight attendant commands; seat belt video
demo, safety procedures for exit seats)
System Administrator Monitoring screen or device

As mentioned above, pre-event delivery process 270 operates to deliver the content before the subject time. For example, if a person is expected to be on FLT 1000, seat 101 on Friday, Dec. 2, 2005, at 3:00 PM, pre-event delivery process 270 will manage the delivery of content to the person prior to the flight. As such, in addition to the operations set forth in TABLE 28, pre-event delivery process 270 can deliver the content to a nodal or specific electronic or physical address, or terminal indicator (e.g., a telephone number. In addition to the outputs set forth in TABLE 29, pre-event delivery process 270 provides contact via an electronic or physical media channel, such as mail, email, messenger, telephone, wireless or land based, television, and radio.

As mentioned above, delivery venue process 275 operates to deliver the content at the subject time. For example, if a person is expected to be on FLT 1000, seat 101 on Friday, Dec. 2, 2005, at 3:00 PM, delivery venue process 275 will manage the delivery of the content to the person during the flight.

As mentioned above, post event delivery process 280 operates to deliver the content after the subject time. For example, if a person is expected to be on FLT 1000, seat 101 on Friday, Dec. 2, 2005, at 3:00 PM, post event delivery process 280 will manage the delivery of content to the person after the flight. In addition to the operations set forth in TABLE 28, post event delivery process 280 can (a) deliver the content to a nodal or specific electronic or physical address, or terminal indicator (e.g., a telephone number), and (b) provide quality indictor responses and interface. In addition to the outputs set forth in TABLE 29, post event delivery process 280 provides (a) contact via an electronic or physical media channel, such as mail, email, messenger, telephone, wireless or land based, television, and radio, (b) quality data, (c) profile data, (d) survey data, and (e) offer acceptance data (feedback from the offeror regarding acceptance by the offeree).

Each of processes 270, 275 and 280 provide feedback data on feedback loop 290. The feedback includes data about a person's use of content, and so, system 200 can determine the user's level of interest in the content, and also identify trends in user interest for a large population of users. As such, system 200 can enhance or improve content. For example, assume that system 200 gives users an opportunity to view movies, and that most users opt to view action movies. Accordingly, for most users, system 200 would be prone to offer an opportunity to view an action movie. However, further assume that Joe Doe has several times been a user of system 200, and on none of those times has he opted to view an action movie, but instead, selected a nature documentary in French. Accordingly, for John Doe, system 200 would be less prone to offer an action movie, and more prone to offer a nature documentary in French. Feedback regarding usage is an iterative and never-ending process that continues to improve the quality of specific offerings to specific persons.

Delivery device process 285 manages delivery of content to a specific or general audience. The delivery may occur at a time and place that the audience is captive. Delivery device process 285 receives data from delivery venue process 275. In addition, delivery device process 285 receives user interface selections, electronic or physical selections, profile schema, credit card and other financial data, and inputs from external devices transmitting commands and data (e.g., cell phone, game pad). Delivery device process 285 performs operations as set forth in TABLE 30, and provides outputs as set forth in TABLE 31.

TABLE 30
Delivery Device Process 285 Operations

Self-declaration data: by touchscreen; credit card, or frequent
flyer/loyalty program card swipes or readers; or other form
of identification
User selections
Execution or storage of selections
User interactions
Process payment information
Manages entire user interface, paper and/or electronic
Accepts and executes interrupts (e.g., pilot, flight crew)
Directs outputs (e.g.,: onboard printer, screen, or other attached device)
Accepts and manages additional user input devices (e.g., Bluetooth ®,
cell phone) (“Bluetooth” is a registered trademark of
Bluetooth SIG, Inc.)
Manages subroutines and algorithms, if required (e.g., shared gaming)
Logging
Attaching metadata
Reacts to all metadata instructions concerning content
Collates and prepares all data for output
Tracks and reports use of content
Manages airline announcements of all types

TABLE 31
Delivery Device Process 285 Outputs

New or updated profile data
User selections and history of selections
Usage: e.g., content, time, prices
Interactivity messages, commands to other locations/addresses
in venue and other devices (e.g., walk around aircraft and play
game on cell phone)
Interrupts required user interface changes (e.g., freeze screen,
blank out, show “please standby”), so an airline can deliver
announcements of all types

Delivery device process 285 also delivers the content to a delivery location. FIG. 2 shows three such delivery locations, namely delivery locations 296, 296A and 296B. Each of delivery locations 296, 296A and 296B can be any suitable venue such as a theater, or an office, or a people-transport vehicle such as an automobile, a bus, a train, an aircraft, a ship or a boat.

Delivery locations 296A and 296B each include a display device with an electronic address, e.g., a computer terminal, namely display devices 297A and 297B, respectively, that receives an Internet stream 298A and 298B, respectively, from the Internet 299. More specifically, Internet stream 298A is routed through a portal 292A to display device 297A at delivery location 296A, and Internet stream 298B is routed through a portal 292B to display device 297B at delivery location 296B. Portal 292A includes control software 294A, and portal 292B includes control software 294B.

Display device 292B and control software 294B operate similarly to display device 292A and control software 294A, respectively. Below, operations of display device 292A and control software 294A are described with an understanding that display device 292B and control software 294B perform similar operations.

Display device 297A can be provided by either (a) an operator of delivery location 296A, e.g., an airline provides a display for an airline passenger, or (b) a user of display device 297A, e.g., the passenger provides a laptop computer. The user of display device 297A may self-declare his or her display device address via a TCP/IP address, or other electronic standard, via a logon. For example the passenger, previously unknown to an Internet provider, connects an electronic device to Internet 299 at a seat on an airplane. By logging on, the passenger self-declares his/her identity via an electronic address, such as a TCP/IP address.

Portal 292A is capable of modifying content flows on Internet stream 298A on the fly, to include changing or eliminating content or substituting content that is personalized for the user. More specifically, control software 294A disintermediates a regular flow of information packets from Internet stream 298A, and changes or substitutes some or all of the regular flow to provide content from system 200 that is personalized for the user. In a case where there is a cost for the user to access the Internet 299, portal control software 294A may reduce the cost by subsidizing Internet viewing time through fees paid by content owners or distributors.

Although portals 292A and 292B operate similarly to one another, they are independent from one another and provide content that is personalized for their respective user. For example, assume that location 296A is a first seat on an aircraft, and that location 296B is a second seat on the same aircraft. Also assume that the user of display device 297A and the user of display device 297B are both watching a movie that that is being broadcast via the Internet 299, and that an advertisement is scheduled to be presented. Since system 200 personalizes content for the individual users, portal 292A may intervene to present an advertisement for a brand of soft drink, while portal 292B may intervene to present an advertisement for a brand of beer.

In another embodiment of system 200, system 200 may include an automatic sales processor 238. A content provider, for example, content provider 230A, accesses automatic sales processor 238, and automatic sales processor 238 provides menu driven options to enable content provider 230A to place an advertisement. Content provider 230A selects options, such as budget or duration of placement, to determine a placement decision and submits the selected options to automatic sales processor 238. Automatic sales processor 238 accesses other system 200 components to analyze, compute and provide appropriate responses to the selected options to content provider 230A. For example, based on the selected options, automatic sales processor 238 invites content provider 230A to select from providing the advertisement to (a) 100 people for $100, (b) 500 people for $400, or (c) 1000 people for $700. Content provider 230A selects a response and uploads an advertisement data file from database 250 for transmission to databases 255 and 260, to store and prepare for delivery. Concurrently, content provider 230A accepts the terms of the advertising decision and submits an electronic acceptance to automatic sales processor 238, forming a contract. An example of the terms of the contract is that (a) the operator of system 200 agrees to provide the advertisement to an audience of 100 people, and (b) content provider 230A agrees to pay $100. Automatic sales processor 238 then sends the terms, as electronic business rules, to accounting database 265 for financial logging, and to database 235 for execution.

For example, assume that content provider 230A is an advertising agency that has prepared an advertisement for television or other form of display. The advertising agency connects to system 200, via an Internet browser for example, and accesses automatic sales processor 238 via an interface page to determine placement and pricing options for the advertisement. The interface page provides an option for the advertising agency to place the advertisement, and further provides options for the advertising agency to enter specific data, such as, but not limited to, budget, audience requirements, personalization criteria, audience size, duration, positioning and price. System 200 then analyzes the data and provides an option for placement of the advertisement. An example of an option would be an advertisement that cost $1.00 for every passenger on all flights between New York and Los Angeles, and the advertisement would run for 2 weeks. The advertising agency may choose that option, or instead, input various other criteria for a different option, such as longer durations, differing audiences or differing prices. After choosing an option, the advertising agency inputs its advertisement data file, i.e., the advertisement, into system 200 for upload, scheduling, delivering and ultimately viewing.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A computer-implemented method comprising:
receiving first data that indicates (a) an identity of a person, (b) a subject location, and (c) a subject time at which said person is expected to be at said subject location;
querying a database, based on said identity, to obtain second data about said person;
matching content to said second data; and
initiating a delivery of said content to a delivery location at a delivery time based on said subject location and said subject time.

2. The method of claim 1, wherein said delivery location is said subject location, and said delivery time is said subject time.

3. The method of claim 1, wherein said delivery location is other than said subject location, and said delivery time is other than said subject time.

4. The method of claim 1, wherein said identity of said person is indicated by a combination of (i) a name of said person and (ii) an attribute associated with said person.

5. The method of claim 4, wherein said attribute is selected from the group consisting of a mailing address, a telephone number, an account number, an email address, and a password.

6. The method of claim 1, wherein said content is in a form selected from the group consisting of an electronic format and a physical form.

7. The method of claim 1,
wherein said first data also indicates a purpose of said person being at said subject location at said subject time, and
wherein said matching is also based on said purpose.

8. The method of claim 1, wherein said subject location is a seat on an aircraft.

9. The method of claim 1, wherein said delivery comprises an act selected from the group consisting of (a) transmitting said content to a user interface situated at said delivery location, (b) sending said content to said delivery location via a delivery service, and (c) having a party present said content at said delivery location.

10. The method of claim 1,
wherein said first data is presented by said person,
wherein said subject location is a current location of said person, and
wherein said subject time is a current time.

11. The method of claim 1, wherein said subject location varies with time.

12. The method of claim 1, wherein said subject location includes an electronic device coupled to a communication network and having an electronic address for receiving said content over said communication network.

13. An apparatus comprising:
a module that receives first data that indicates (a) an identity of a person, (b) a subject location, and (c) a subject time at which said person is expected to be at said subject location;
a module that queries a database, based on said identity, to obtain second data about said person;
a module that matches content to said second data; and
a module that initiates a delivery of said content to a delivery location at a delivery time based on said subject location and said subject time.

14. The apparatus of claim 13, wherein said delivery location is said subject location, and said delivery time is said subject time.

15. The apparatus of claim 13, wherein said delivery location is other than said subject location, and said delivery time is other than said subject time.

16. The apparatus of claim 13, wherein said identity of said person is indicated by a combination of (i) a name of said person and (ii) an attribute associated with said person.

17. The apparatus of claim 16, wherein said attribute is selected from the group consisting of a mailing address, a telephone number, an account number, an email address, and a password.

18. The apparatus of claim 13, wherein said content is in a form selected from the group consisting of an electronic format and a physical form.

19. The apparatus of claim 13,
wherein said first data also indicates a purpose of said person being at said subject location at said subject time, and
wherein said match is also based on said purpose.

20. The apparatus of claim 13, wherein said subject location is a seat on an aircraft.

21. The apparatus of claim 13, wherein said delivery comprises an act selected from the group consisting of (a) transmitting said content to a user interface situated at said delivery location, (b) sending said content to said delivery location via a delivery service, and (c) having a party present said content at said delivery location.

22. The apparatus of claim 13,
wherein said first data is presented by said person,
wherein said subject location is a current location of said person, and
wherein said subject time is a current time.

23. The apparatus of claim 13, wherein said subject location varies with time.

24. The apparatus of claim 13, wherein said subject location includes an electronic device coupled to a communication network and having an electronic address for receiving said content over said communication network.

25. A storage media, comprising:
program instructions for controlling a processor to receive first data that indicates (a) an identity of a person, (b) a subject location, and (c) a subject time at which said person is expected to be at said subject location;
program instructions for controlling a processor to query a database, based on said identity, to obtain second data about said person;
program instructions for controlling a processor to match content to said second data; and
program instructions for controlling a processor to initiate a delivery of said content to a delivery location at a delivery time based on said subject location and said subject time.
